(19) United States
(12) Patent Application Publication
(10) Pub. No.: US 2020/0282300 A1
(43) Pub. Date: Sep. 10, 2020

(54) TOY GRABBING MECHANISM

(71) Applicant: LI HSEN PLASTICS CO., LTD., New Taipei City (TW)

(72) Inventor: SAN-LANG CHIANG, NEW TAIPEI CITY (TW)

(21) Appl. No.: 16/881,014

(22) Filed: May 22, 2020

Related U.S. Application Data
(63) Continuation-in-part of application No. 16/280,056, filed on Feb. 20, 2019.

(51) Int. Cl. A63F 9/30; B25J 15/10

(52) U.S. Cl. CPC A63F 9/30; A63F 11/00; B25J 15/10

(57) ABSTRACT

A toy grabbing mechanism for catching or gripping a toy includes a main body, claw members, and a movable member. The main body has holes. The claw members each have a gripping portion, a pivoting portion and a balancing portion. A balancing portion is provided at one end of the claw members penetrating through the elliptical holes respectively. A gripping space is defined between the gripping portions of the claw members. The pivoting portions are pivotally connected to the movable member and surround the main body. During operation, when the three claw members are in contact with a surface of the toy and the toy exerts pressure on all of the three claw members, the three claw members are extended in a way such that a volume of the gripping space is increased to completely encompass the surface of the toy.

### CROSS-REFERENCE TO RELATED APPLICATIONS

This application is a continuation-in-part patent application of U.S. application Ser. No. 16/280,056 filed on Feb. 20, 2019, the entire contents of which are hereby incorporated by reference for which priority is claimed under 35 U.S.C. § 120.

### FIELD OF THE INVENTION

The present invention relates to a toy grabbing mechanism, and more particularly to a toy grabbing mechanism for catching or gripping a toy.

### BACKGROUND OF THE INVENTION

Since ancient times, many games have been invented and improved, thereby enhancing the relationship and friendship between parents and peers and helping the development of physical and mental health and coordination. A fishing toy is one of the common toys, which simulates the activity of catching fish. Toy fish and toy fishing poles are equipped with magnetic parts. The toy fishing poles are used to catch toy fish by means of magnetic attraction. However, a conventional fishing toy is relatively easy to play the toy fishing game. It uses the toy fishing pole to catch toy fish only, but cannot catch other items. Moreover, the toy fishing game does not require physical coordination, reducing the fun for challenge.

In the meantime, a claw machine is a fixed electronic machine that uses electrically to drive suspended claws and control the position of the claws through buttons provided on the machine to catch the prizes placed in the machine. However, the existing claw machines are large-sized electronic machines for playing a game by catching prizes. The user needs to go to the machine and drops coins into the machine to play the game, thereby providing the user with amusement, which limits the place where the user entertains.

Accordingly, the inventor of the present invention has devoted himself based on his many years of practical experiences to solve these problems and develop a toy grabbing mechanism that improves the shortcomings of conventional fishing toys and claw machines and enhances the user's physical coordination and has better amusement and challenge.

### SUMMARY OF THE INVENTION

The primary object of the present invention is to provide a toy grabbing mechanism for catching or gripping a toy, which is a simple and fun toy.

In order to achieve the above object, the present invention provides a toy grabbing mechanism for catching or gripping a toy. The toy grabbing mechanism comprises a main body, three claw members, and a movable member. a main body, having three elliptical holes which are separated from each other with equal distance; three claw members, each being a curve plate structure corresponding to a shape of the toy, the claw members each having a gripping portion having a curve surface, wherein a middle portion of each of the claw members has a pivoting portion having a ring shape, and a balancing portion is provided at one end of the claw members penetrating through the elliptical holes respectively, wherein a gripping space is defined between the gripping portions of the claw members, the gripping portions are separated by a predetermined distance respectively; and a movable member, being an annular torus having a radius larger than a radius of the main body, the movable member being provided with three recesses, and the pivoting portions of the claw members being pivotally connected to the recesses, during operation, when the three claw members are in contact with a surface of the toy and the toy exerts pressure on all of the three claw members, the three claw members are extended in a way such that a volume of the gripping space is increased to completely encompass the surface of the toy. Thereby, the toy grabbing mechanism improves the shortcomings of conventional fishing toys and claw machines, and enhances the user's physical coordination during the game by controlling the main body, and has better amusement and challenge.

In addition, the movable member has an annular configuration and a plurality of recesses, and the pivoting portions of the claw members are pivotally connected to the recesses respectively to increase the stability of the pivoting portions pivotally connected to the movable member.

Furthermore, the pivoting portion has an arc shape for being pivotally connected to a corresponding one of the recesses. Thereby, the stability of the pivoting portions pivotally connected to the recesses can be improved, and the stability that the claw members are pivoted about the pivoting portions can be improved.

Preferably, the gripping portion has a curved configuration, which is beneficial for gripping the toy and increases the gripping stability.

Besides, the toy grabbing mechanism further comprises a long rod connected to the main body for a user to hold the long rod to control the main body.

Furthermore, the long rod is provided with a telescopic portion for changing a length and flexibility of the long rod, increasing the difficulty of the game and enhancing the amusement effect.

In addition, one side of the gripping portion for gripping the toy has a plurality of protrusions to increase the stability of the gripping portion for gripping the toy.

In another embodiment, one side of the gripping portion for gripping the toy has at least one pad to increase the friction coefficient of the gripping portion, thereby improving the stability of the gripping portion for gripping the toy.

Besides, the main body, the movable member and the claw members are made of a plastic material. Through the low-density properties of plastic materials, it is easy for users to play the game.

In summary, the toy grabbing mechanism of the present invention is used for catching or gripping a toy, thereby training the user's physical coordination. The user can manipulate the main body to move the movable member and further manipulate the claw members for catching and gripping the toy. Therefore, the toy grabbing mechanism has better amusement and challenge.

### BRIEF DESCRIPTION OF THE DRAWINGS

FIG. 1 is a perspective view in accordance with a preferred embodiment of the present invention;

FIG. 2A is a first schematic view of the operating toy grabbing mechanism in accordance with the preferred embodiment of the present invention when in use;

FIG. 2B is a second schematic view of the operating toy grabbing mechanism in accordance with the preferred embodiment of the present invention when in use;

FIG. 2C is a third schematic view of the operating toy grabbing mechanism in accordance with the preferred embodiment of the present invention when in use;

FIG. 2D is a fourth schematic view of the operating toy grabbing mechanism in accordance with the preferred embodiment of the present invention when in use;

FIG. 3 is another view in accordance with the preferred embodiment of the present invention when in use;

FIG. 4 is a perspective view of the main body in accordance with the preferred embodiment of the present invention;

FIG. 5 is a perspective view of the movable member in accordance with the preferred embodiment of the present invention;

FIG. 6 is a perspective view of the claw member in accordance with the preferred embodiment of the present invention;

FIG. 7 is a perspective view in accordance with another embodiment of the present invention; and

FIG. 8 is a perspective view of the claw member in accordance with another embodiment of the present invention.

### DETAILED DESCRIPTION OF THE PREFERRED EMBODIMENTS

Embodiments of the present invention will now be described, by way of example only, with reference to the accompanying drawings.

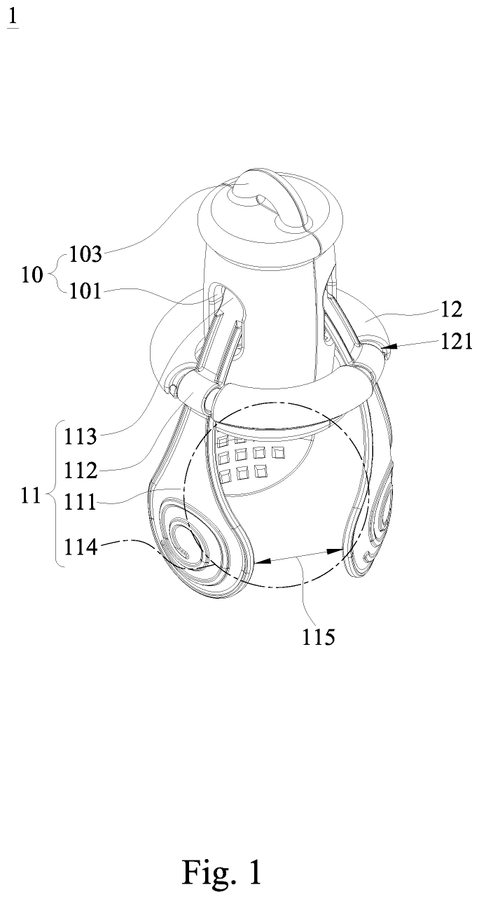

As shown in FIGS. 1-6, the present invention discloses a toy grabbing mechanism 1 for catching or gripping a toy 2, comprising a main body 10, three claw members 11, and a movable member 12. The main body 10 has three elliptical holes 101 which are separated from each other with equal distance. The toy grabbing mechanism 1 further comprises an accommodating space 102. The accommodating space 102 is in communication with the holes 101. In the embodiment, the main body 10 further has a pull ring 103. In addition, each of the three claw members 11 is a curve plate structure corresponding to a shape of the toy 2; each of the claw members 11 has a gripping portion 111 which is a curve surface. A middle portion of each of the claw members 11 has a pivoting portion 112 having a ring shape, and a balancing portion 113 is provided at one end of the claw members 11 penetrating through the elliptical holes 101 respectively. A gripping space 114 is defined between the gripping portions 111 of the claw members 11, the gripping portions 112 are separated by a predetermined distance 115 respectively. It is worth noting that the balancing portion 113 is slightly larger than the holes 101. And the upper part of the holes 101 is slightly larger than an end of the balancing portion 113. The movable member 12 is an annular torus larger than the main body 10. The movable member 12 is provided with three recesses 121, and the pivoting portions 112 of the claw members 11 are pivotally connected to the recesses 121. When the movable member 12 is moved, the movable member 12 is moved up and down relative to the main body 10. The claw members 11 are pivotable about the pivoting portions 112 to change the gripping space 114 for the gripping portions 111 to catch and grip the toy 2.

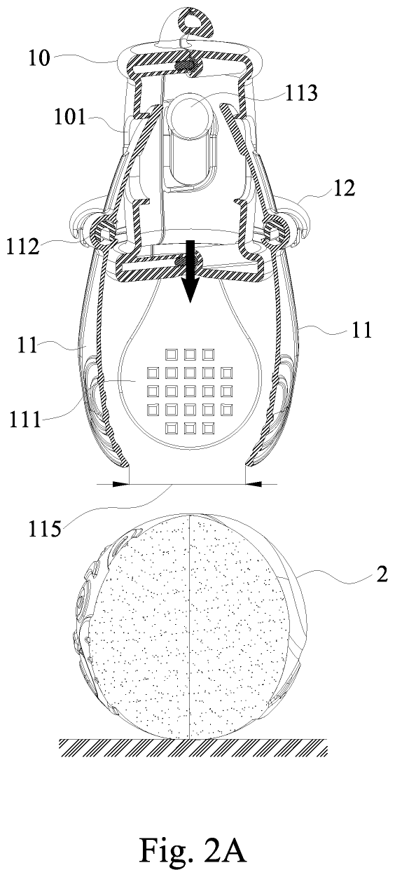

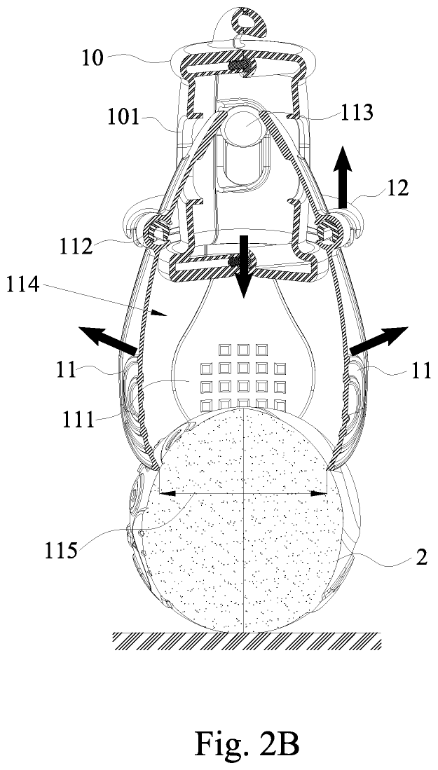

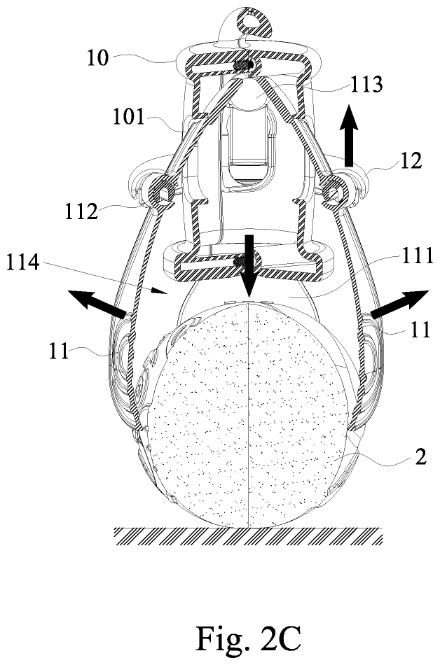

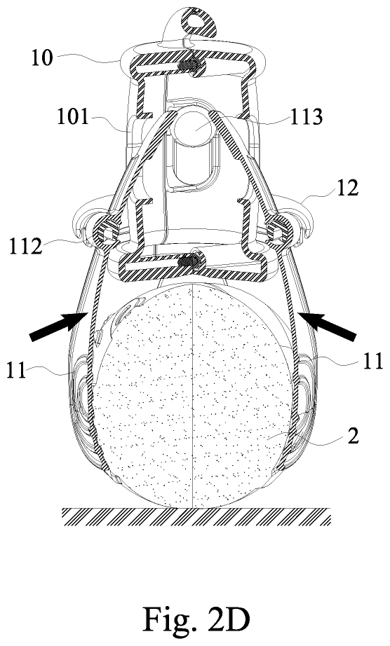

Preferably, as seen in FIG. 2A, 2B, 2C, 2D, when the user plays the game, the user controls the main body 10 to change the relative position between the main body 10 and the movable member 12, such that the movable member 12 is moved up and down relative to the main body 10. In this embodiment, the toy 2 is a toy ball and placed on a plane, such as on the ground or on a table. The user uses the toy grabbing mechanism 1 to grip the toy 2 for playing the game. During operation, when the three claw members 11 are in contact with a surface of the toy 2 and the toy 2 exerts pressure on all of the three claw members 11, the movable member 12 is pushed upward and the three claw members 11 are extended in a way such that a volume of the gripping space 114 is increased to completely encompass the surface of the toy 2.

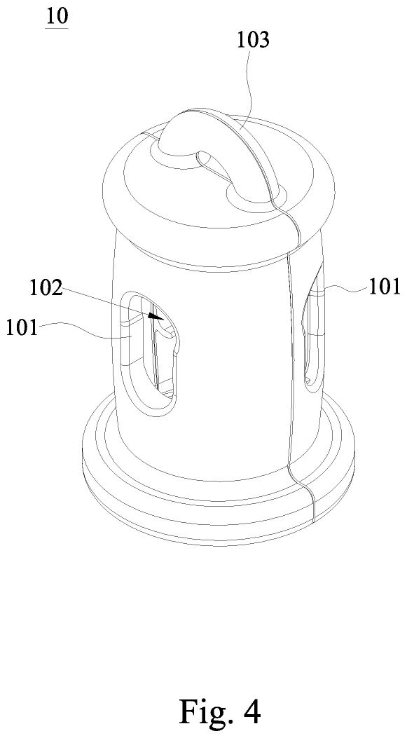

In addition, the balancing portions 113 are disposed in the holes 101 and actuated in the accommodating space 102, so that the balancing portions 113 are limited by the size of the accommodating space 102. FIG. 4 illustrates the structure of the main body. The holes 101 each have a capsule-like shape. The hole 101 includes two arcs with different radii to limit the actuation of any one of the balancing portions 113. In a specific situation, the balancing portions 113 are moved to touch each other, thereby limiting the angle of rotation of the balancing portions 113 relative to the pivoting portions 112. In this way, the balancing portions 113 can be prevented from being disengaged from the min body 10 to facilitate the gripping operation.

Furthermore, following the above description, when the movable member 12 is moved upward relative to the main body 10, the pivoting portions 112 are moved upward together with the movable member 12. Since the lengths of the gripping portions 111 and the balancing portions 113 relative to the pivoting portions 112 are different, and the movable member 12 may have a leftward or rightward movement relative to the min body 10, and the factors such as relative acceleration and air resistance, the balance of the claw members 11 may be affected. Therefore, the balancing portions 113 are rotated relative to the pivoting portions 112 toward the center of the main body 10. The gripping portions 111 are rotated relative to the pivoting portions 112 away from the gripping space 114, so that the gripping space 114 is enlarged for gripping the toy 2.

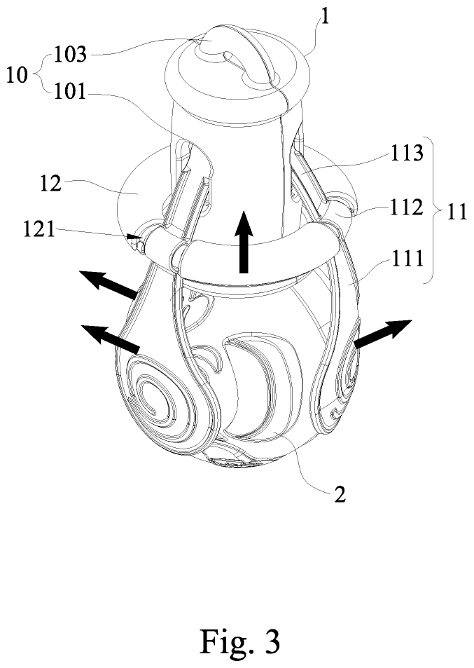

FIG. 3 is a second schematic view of the present invention when in use. When the toy 2 is already in the gripping space 114, if the user wants to release the toy 2, the user need to move the movable member 12 upward manually. Similarly, at this time, the balancing portions 113 are rotated relative to the pivoting portions 112 toward the center of the main body 10 to sequentially open the claw members 11, and the gripping portions 111 are rotated relative to the pivoting portions 112 toward the gripping space 114, so that the gripping space 114 is reduced to grip the toy 2. Then, the main body 10 is controlled to be away from the plane on which the toy 2 is placed, so that the toy grabbing mechanism 1 and the toy 2 are moved together away from the plane to achieve the gripping effect.

In another embodiment, the toy 2 is a mobile toy ball, and the user can catch the toy 2 as the foregoing description. Thereby, the invention improves the shortcomings of conventional fishing toys and claw machines. Manipulating the main body 10 requires physical coordination and is more challenging to catch or grip the toy 2. In this way, the toy grabbing mechanism 1 is a challenging and fun toy that can be played at home or outdoors.

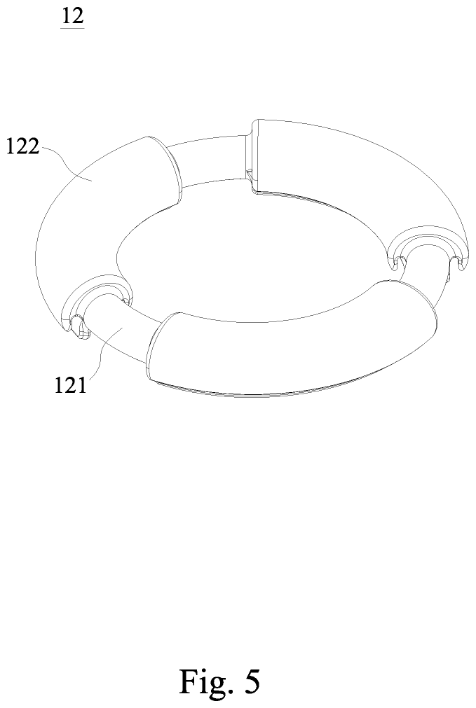

FIG. 5 illustrates the structure of the movable member. The movable member 12 has an annular configuration. In this embodiment, the movable member 12 is provided with a plurality of outer casings 122. A recess 121 is formed between every adjacent two of the outer casings 122 so that the pivoting portion 12 is pivotally connected to the recess 121. The outer casings 122 are in a fixed state to limit and retain the size of the recess 121, thereby avoiding the horizontal movement of the pivoting portions 112 on the movable member 12 during the game, such that the pivoting portions 112 are pivotally connected to the recesses 121 stably to enhance the stability. Furthermore, the pivoting portion 112 has an arc shape for being pivotally connected to the recess 121. In this way, the stability of the pivoting portions 112 pivotally connected to the recesses 121 can be improved, and the stability that the claw members 11 are pivoted about the pivoting portions 112 can be improved.

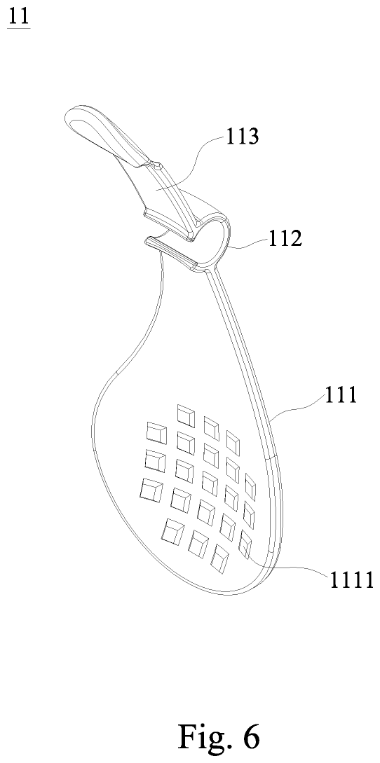

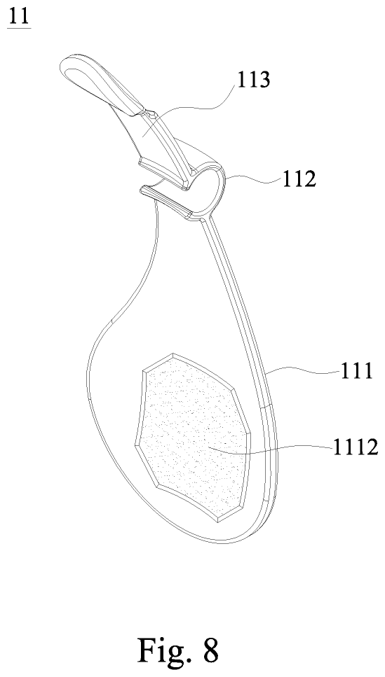

Furthermore, FIG. 6 illustrates the structure of the claw member. One side of the gripping portion 111 for gripping the toy 2 has a plurality of protrusions 1111. In another embodiment, as shown in FIG. 8, one side of the gripping portion 111 for gripping the toy 2 has at least one pad 1112. Therefore, the frictional coefficient of the side of the gripping portion 111 for gripping the toy 2 can be increased through the protrusions 1111 or the pad 1112, thereby enhancing the stability for the gripping portions 111 to grip the toy 2.

Preferably, the gripping portion 111 has a curved configuration. The concave surface of the gripping portion 111 faces the gripping space 114. Therefore, the gripping portion 111 has a large contact area with the toy 2, which is beneficial for gripping the toy 2, in particular to grip a spheral toy 2. Moreover, the clamping stability can be enhanced.

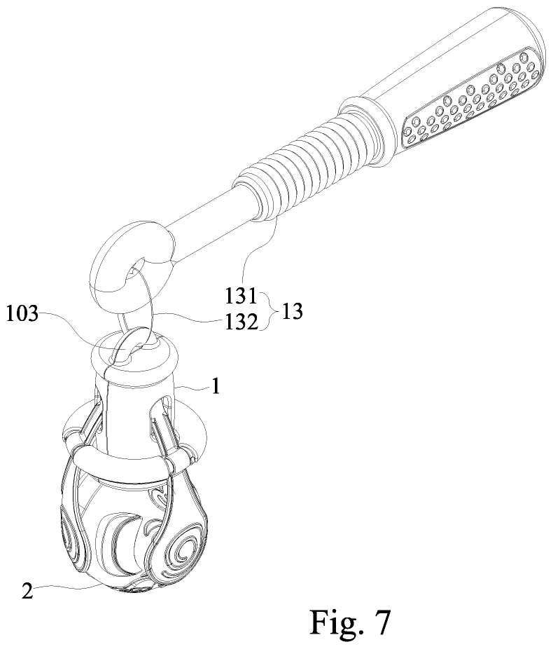

FIG. 7 is a perspective view in accordance with another embodiment of the present invention. The toy grabbing mechanism 1 further comprises a long rod 13. The long rod 13 is provided with a buckle ring 132. The buckle ring 132 is connected to the pull ring 103. Therefore, the user can hold the long rod 13 and control the main body 10 to play the game through the long rod 13. In addition, by manipulating the long rod 13 to control the main body 10, the difficulty of manipulating the main body 10 is increased and the challenge of the game is increased, thereby enhancing the amusement effect.

Furthermore, the long rod 13 is provided with a telescopic portion 131. In this embodiment, the telescopic portion 131 is a telescopic collar structure. The collar structure of the telescopic portion 131 includes a plurality of collars each having an equal cross-sectional area and connected to each other, and has elasticity and bounce property for changing the length and flexibility of the long rod 13. Thereby, the toy grabbing mechanism 1 not only simulates the activity of fishing but also enhances the difficulty of the game, further enhancing the challenge and amusement effect.

Preferably, the number of the claw members 11 is three, which is beneficial for gripping the toy 2. When the number of the claw members 11 is two, the catching stability is poor. It is more difficult to grip the toy 2 through the claw members 11, reducing the user's willingness to play the game. On the other hand, when the number of the claw members 11 is four, there may be too many of the balancing portions 113 in the accommodating space 102, causing the balancing portions 113 to collide with each other easily during the game and reducing the maximum rotation angle when any one of the balancing portions 113 is actuated. Similarly, when the number of the claw members 11 is five or more, it is more unfavorable for operation. On the other hand, since the claw members 11 are connected to the holes 101 and the recesses 121, the numbers of the claw members 11, the holes 101 and the recesses 121 must be the same. If the number of the claw members 11 is four or more, the production cost of the toy grabbing mechanism 1 is increased. In this way, the toy grabbing mechanism 1 is provided with three claw members 11, which is cost-effective and provides a better gripping effect.

In addition, the main body 10, the movable member 12 and the claw members 11 are made of a plastic material, and more particularly to a hard material. Preferably, the toy 2 is also made of a plastic material. Thereby, through the low density, good toughness and low cost of plastic materials, it is easy for users to play the game.

In summary, the toy grabbing mechanism 1 of the present invention is used for catching or gripping the toy 2, thereby training the physical coordination and providing amusement and challenge. The user can manipulate the main body 10 to move the movable member 12 relative to the main body 10 and further manipulate the claw members 11 to change the gripping space 114 for catching and gripping the toy 2. The pivoting portions 112 each having an arc shape are pivotally connected to the recesses 121, thereby improving the stability. The toy grabbing mechanism 1 improves the shortcomings of conventional fishing toys and claw machines and enhances the user's physical coordination during the game and has better amusement and challenge.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A toy grabbing mechanism, for catching or gripping a toy, comprising:
a main body, having three elliptical holes which are separated from each other with equal distance;
three claw members, each being a curve plate structure corresponding to a shape of the toy, the claw members each having a gripping portion which is a curve surface, wherein a middle portion of each of the claw members has a pivoting portion having a ring shape, and a balancing portion is provided at one end of the claw members penetrating through the elliptical holes respectively, wherein a gripping space is defined between the gripping portions of the claw members, the gripping portions are separated by a predetermined distance respectively; and
a movable member, being an annular torus having a radius larger than a radius of the main body, the movable member being provided with three recesses, and the pivoting portions of the claw members being pivotally connected to the recesses,
during operation, when the three claw members are in contact with a surface of the toy and the toy exerts pressure on all of the three claw members, the movable member is pushed upward, the three claw members are extended in a way such that a volume of the gripping space is increased to completely encompass the surface of the toy.

2. The toy grabbing mechanism as claimed in claim 1, further comprising a long rod pivotally connected to a top of the main body for a user to hold the long rod.

3. The toy grabbing mechanism as claimed in claim 2, wherein the long rod is provided with a telescopic portion for adjusting a length and flexibility of the long rod.

4. The toy grabbing mechanism as claimed in claim 3, wherein an inner side of the gripping portion for gripping the toy has a plurality of protrusions.

5. The toy grabbing mechanism as claimed in claim 3, wherein one side of the gripping portion for gripping the toy has at least one pad.

6. The toy grabbing mechanism as claimed in claim 1, wherein the main body, the movable member and the claw members are made of a plastic material.
